(19) United States
(12) Patent Application Publication
(10) Pub. No.: US 2026/0328103 A1
(43) Pub. Date: Oct. 22, 2026

(54) COMPOSITE VARIABLE STATOR VANE IN TURBINE ENGINES

(71) Applicant: General Electric Company, Evendale, OH (US)

(72) Inventors: Nicholas J. Kray, Mason, OH (US); Ming Xie, Dayton, OH (US); Douglas Lorrimer Armstrong, Needham, MA (US)

(21) Appl. No.: 19/181,524

(22) Filed: Apr. 17, 2025

(51) Int. Cl. F01D 9/02; F01D 5/14

(52) U.S. Cl. CPC F01D 9/02; F01D 5/147; F05D 2220/323; F05D 2240/12; F05D 2300/603

(57) ABSTRACT

A variable stator vane includes a shaft defining a longitudinal axis of the variable stator vane, the shaft having a first metallic end and a second metallic end coupled to a shaft portion, the shaft portion being made essentially of a first composite material to reduce weight of the variable stator vane. The variable stator vane further includes an airfoil portion coupled to the shaft portion, the airfoil portion being made essentially of a second composite material. The shaft and the airfoil portion are rotatable around the longitudinal axis of the variable stator vane.

### TECHNICAL FIELD

The present disclosure relates generally to composite variable stator vanes in turbine engines.

### BACKGROUND

Gas turbine engines generally include a fan and a turbo-engine arranged in flow communication with one another, with the turbo-engine disposed downstream of the fan in a direction of flow through the gas turbine engine. The turbo-engine generally includes, in serial flow order, a compressor section, a combustion section, a turbine section, and an exhaust section. With multi-shaft gas turbine engines, the compressor section can include a high pressure (HP) compressor disposed downstream of a low pressure (LP) compressor, and the turbine section can similarly include a low pressure (LP) turbine disposed downstream of a high pressure (HP) turbine. The combustion section includes a combustor that generates combustion gases discharged into the turbine section. With such a configuration, the HP compressor is coupled with the HP turbine via a high pressure (HP) shaft, and the LP compressor is coupled with the LP turbine via a low pressure (LP) shaft. The LP compressor, the HP compressor, the LP turbine, and the HP turbine may, for example include variable stator vanes (VSVs).

### BRIEF DESCRIPTION OF THE DRAWINGS

Features and advantages will be apparent from the following, more particular, description of various embodiments, as illustrated in the accompanying drawings, wherein like reference numbers generally indicate identical, functionally similar, or structurally similar elements, or both.

FIG. 1 is a schematic, cross-sectional view of a turbine engine, taken along a longitudinal centerline axis of the turbine engine, according to an embodiment of the present disclosure.

FIG. 2 is a schematic, perspective view of a variable stator vane (VSV) having a shaft, according to an embodiment of the present disclosure.

FIG. 3A is a schematic, cross-sectional view of a shaft portion of the shaft of the VSV, according to an embodiment of the present disclosure.

FIG. 3B is a schematic, cross-sectional view of the shaft portion of the shaft taken at line 3B-3B, shown in FIG. 3A, according to an embodiment of the present disclosure.

FIG. 4A is a schematic, elevational view of a first metallic end of the shaft, as shown in FIG. 2, according to an embodiment of the present disclosure.

FIG. 4B is a schematic, elevational view of a second metallic end of the shaft, as shown in FIG. 2, according to an embodiment of the present disclosure.

FIG. 4C is a schematic, cross-sectional view of the first metallic end taken at line 4C-4C shown in FIG. 4A, according to an embodiment of the present disclosure.

FIG. 4D is a schematic, cross-sectional view of the second metallic end taken at line 4D-4D shown in FIG. 4A, according to an embodiment of the present disclosure.

FIG. 5 is a schematic, cross-sectional view of the VSV taken at line 5-5 shown in FIG. 2, according to an embodiment of the present disclosure.

FIG. 6 is a schematic, cross-sectional view of the VSV taken along line 6-6 shown in FIG. 2, according to an embodiment of the present disclosure.

### DETAILED DESCRIPTION

Features, advantages, and embodiments of the present disclosure are set forth or apparent from a consideration of the following detailed description, drawings, and claims. Moreover, both the foregoing summary of the present disclosure and the following detailed description are exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first” and “second” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “low” and “high,” or their respective comparative degrees (e.g., “lower” and “higher,” where applicable), when used with the compressor, turbine, shaft, or spool components, each refers to relative pressures or relative speeds, or both within an engine unless otherwise specified. For example, a “low-speed” component defines a component configured to operate at a rotational speed, such as a maximum allowable rotational speed, which is lower than that of a “high-speed” component of the engine. Alternatively, unless otherwise specified, the aforementioned terms may be understood in their superlative degree. For example, a “low-pressure turbine” may refer to the lowest maximum pressure within a turbine section, and a “high-pressure turbine” may refer to the highest maximum pressure within the turbine section. The terms “low” or “high” in such aforementioned terms may additionally, or alternatively, be understood as relative to minimum allowable speeds or pressures, or minimum or maximum allowable speeds or pressures relative to normal, desired, steady state, etc., operation of the engine, or any combination thereof.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the term “axial” refers to directions and orientations that extend substantially parallel to a longitudinal centerline axis of the turbine engine. Moreover, the terms “radial” and “radially” refer to directions and orientations that extend substantially perpendicular to the longitudinal centerline axis of the turbine engine. In addition, as used herein, the term “circumferentially” refers to directions and orientations that extend arcuately about the longitudinal centerline axis of the turbine engine.

An embodiment of the present disclosure provides variable pitch composite vanes, also referred to variable stator vanes (VSVs), in a turbine engine. With the increased use of variable stator vanes (e.g., VSVs), weight opportunities exist for composite use. VSVs are typically supported at the inner diameter (ID) and the outer diameter (OD) of the vanes. A VSV is configured to rotate around a longitudinal axis of the VSV to direct airflow. To maximize weight savings, the VSV should be made with as much composite material as possible. The VSV is generally provided with a shaft (also referred to as a trunnion, a spar, or a spindle) defining the longitudinal axis of the VSV and an airfoil portion connected to the shaft. In addition to using a composite material for the airfoil portion of the VSV, the shaft is also made of a composite material to further reduce the weight. For example, the shaft can be a perfect candidate for using a braided composite architecture where longitudinal fibers add stiffness and off-angle fibers add torsional rigidity. The airfoil portion of the VSV is then formed by wrapping a composite material around the composite shaft. Metal components may be incorporated at the ends of the shaft to add rigidity and to provide wear resistance.

In an embodiment, the metal components provided at the ends of the shaft do not exceed twenty-five percent (25%) of a total span of the VSV. In an embodiment, the metal components provided at the ends of the shaft are between ten percent (10%) and twenty-five percent (25%).

In an embodiment, the shaft may be made of a different composite material than the composite material of the airfoil portion of the VSV.

In an embodiment, the shaft may have a different composite architecture than the architecture of the airfoil portion of the VSV. For example, the shaft may be a laminate while the airfoil portion may be braided.

In an embodiment, the airfoil portion is a composite overwrap of the composite shaft.

In an embodiment, the airfoil portion may include a non-composite material, such as foam. For example, the non-composite material (e.g., foam) can be provided within the airfoil portion near the shaft.

In an embodiment, ends of the shaft may include metallic bushings for wear capability.

The term “composite,” as used herein, is indicative of a component material having two or more constituent materials. A composite can be a combination of at least two or more metallic, non-metallic, or a combination of metallic and non-metallic elements or materials. Examples of a composite material can be, but not limited to, a polymer matrix composite (PMC), a ceramic matrix composite (CMC), a metal matrix composite (MMC), carbon fibers, a polymeric resin, a thermoplastic resin, bismaleimide (BMI) materials, polyimide materials, an epoxy resin, glass fibers, and silicon matrix materials. The composite may be formed of a matrix material and a reinforcing element, such as a fiber (referred to herein as a reinforcing fiber).

As used herein, “reinforcing fibers” may include, for example, glass fibers, carbon fibers, steel fibers, or para-aramid fibers, such as Kevlar® available from DuPont of Wilmington, Delaware. The reinforcing fibers may be in the form of fiber tows that include a plurality of fibers that are formed into a bundle. The polymeric matrix material may include, for example, thermoset resin, bismaleimide (BMI) materials, polyimide materials, or thermoplastic resin.

“Preform” as used herein is a piece of three-dimensional composite woven fabric formed by a plurality of reinforcing fibers including warp fiber tows and weft fiber tows.

As used herein, a “composite component” refers to a structure or a component including any suitable composite material. Composite components, such as a composite airfoil (e.g., a composite fan blade or a composite variable stator vane or VSV), can include several layers or plies of composite material (composite plies). The layers or plies can vary in stiffness, material, and dimension to achieve the desired composite component or composite portion of a component having a predetermined weight, size, stiffness, and strength.

One or more layers of adhesive can be used in forming or coupling composite components. Adhesives can include resin and phenolics, wherein the adhesive can require curing at elevated temperatures or other hardening techniques.

As may be used herein, PMC refers to a class of materials. The PMC material may be a prepreg. A prepreg is a reinforcement material (e.g., a reinforcing fiber) pre-impregnated with a polymer matrix material, such as thermoplastic resin. Non-limiting examples of processes for producing thermoplastic prepregs include hot melt pre-pregging in which the fiber reinforcement material is drawn through a molten bath of resin and powder pre-pregging in which a resin is deposited onto the fiber reinforcement material, by way of a non-limiting example, electrostatically, and then adhered to the fiber, by way of a non-limiting example, in an oven or with the assistance of heated rollers.

Resins for matrix materials of PMCs can be generally classified as thermoset resin polymers or thermoplastic resin polymers. Thermoplastic resin polymers are generally categorized as polymers that can be repeatedly softened and caused to flow when heated, and hardened, when sufficiently cooled due to physical rather than chemical changes. Notable example classes of thermoplastic resin polymers include nylons, thermoplastic polyesters, polyaryletherketones, and polycarbonate resins. A specific example of high-performance thermoplastic resins that have been contemplated for use in aerospace applications include polyetheretherketone (PEEK), polyetherketoneketone (PEKK), polyetherimide (PEI), polyaryletherketone (PAEK), and polyphenylene sulfide (PPS). In contrast, once fully cured into a hard rigid solid, thermoset resins do not undergo significant softening when heated, but instead, thermally decompose when sufficiently heated. Notable examples of thermoset resin polymers include epoxy, bismaleimide (BMI), and polyimide resins.

Instead of using a prepreg with thermoplastic polymers, another non-limiting example utilizes a woven fabric. A woven fabric can include, but is not limited to, dry carbon fibers woven together with thermoplastic polymer fibers or filaments. Non-prepreg braided architectures can be made in a similar fashion. With this approach, it is possible to tailor the fiber volume of the part by dictating the relative concentrations of the thermoplastic fibers and reinforcement fibers that have been woven or braided together. Additionally, different types of reinforcement fibers can be braided or woven together in various concentrations to tailor the properties of the part. For example, glass fibers, carbon fibers, and thermoplastic fibers could all be woven together in various concentrations to tailor the properties of the part. Although the carbon fibers provide the strength of the system, the glass fibers can be incorporated to enhance the impact properties, which is a design characteristic for parts located near the inlet of the engine, and the thermoplastic fibers provide the binding for the reinforcement fibers.

In yet another non-limiting example, resin transfer molding (RTM) can be used to form at least a portion of a composite component. Generally, RTM includes the application of dry fibers to a mold or a cavity. The dry fibers can include prepreg, braided material, woven material, or any combination thereof. Resin can be pumped into or otherwise provided to the mold or the cavity to impregnate the dry fibers. The combination of the impregnated fibers and the resin is then cured and removed from the mold. When removed from the mold, the composite component can require post-curing processing. RTM may be a vacuum assisted process. That is, the air from the cavity or the mold can be removed and replaced by the resin prior to heating or curing. The placement of the dry fibers can be manual or automated. The dry fibers can be contoured to shape the composite component or to direct the resin. Optionally, additional layers or reinforcing layers of a material differing from the dry fiber can also be included or added prior to heating or curing.

As used herein, CMC refers to a class of materials with reinforcing fibers in a ceramic matrix. Generally, the reinforcing fibers provide structural integrity to the ceramic matrix. Some examples of reinforcing fibers can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Some examples of ceramic matrix materials can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) can also be included within the ceramic matrix.

Generally, particular CMCs can be referred to as their combination of type of fiber/type of matrix. For example, C/SiC for carbon-fiber-reinforced silicon carbide, SiC/SiC for silicon carbide-fiber-reinforced silicon carbide, SiC/SiN for silicon carbide fiber-reinforced silicon nitride, SiC/SiC—SiN for silicon carbide fiber-reinforced silicon carbide/silicon nitride matrix mixture, etc. In other examples, the CMCs can be comprised of a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al₂O₃·2SiO₂), as well as glassy aluminosilicates.

In certain non-limiting examples, the reinforcing fibers may be bundled (e.g., form fiber tows) and/or coated prior to inclusion within the matrix. The bundles of fibers may be impregnated with a slurry composition prior to forming the preform or after formation of the preform. The preform may then undergo thermal processing, and subsequent chemical processing to arrive at a component formed of a CMC material having a desired chemical composition. For example, the preform may undergo a cure or a burn-out to yield a high char residue in the preform, and subsequent melt-infiltration with silicon, or a cure or a pyrolysis to yield a silicon carbide matrix in the preform, and subsequent chemical vapor infiltration with silicon carbide. Additional steps may be taken to improve densification of the preform, either before or after chemical vapor infiltration, by injecting the preform with a liquid resin or a polymer followed by a thermal processing step to fill the voids with the silicon carbide. A CMC material as used herein may be formed using any known or hereafter developed methods including, but not limited to, melt infiltration, chemical vapor infiltration, polymer impregnation pyrolysis (PIP), or any combination thereof.

The term “metallic” as used herein is indicative of a material that includes metal such as, but not limited to, titanium, iron, aluminum, stainless steel, and nickel alloys. A metallic material or an alloy can be a combination of at least two or more elements or materials, where at least one is a metal.

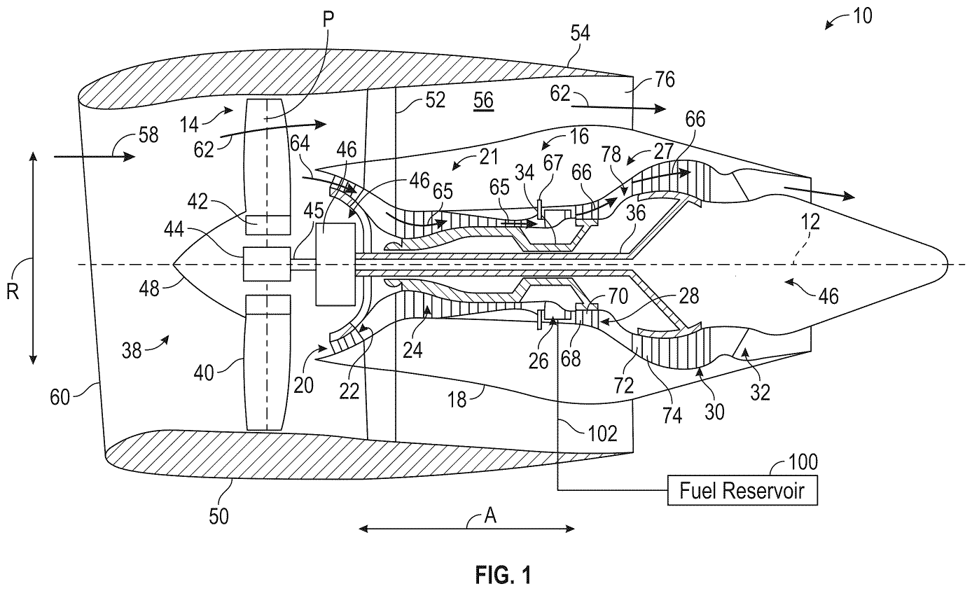

Referring now to the drawings, FIG. 1 is a schematic, cross-sectional view of a turbine engine 10, taken along a longitudinal centerline axis 12 of the turbine engine 10, according to an embodiment of the present disclosure. As shown in FIG. 1, the turbine engine 10 defines an axial direction A (extending parallel to the longitudinal centerline axis 12 provided for reference) and a radial direction R that is normal to the axial direction A. In general, the turbine engine 10 includes a fan section 14 and a turbo-engine 16 disposed downstream from the fan section 14.

The turbo-engine 16 depicted in FIG. 1 generally includes an outer casing 18 that is substantially tubular and defines an annular inlet 20. As schematically shown in FIG. 1, the outer casing 18 encases, in serial flow relationship, a compressor section 21 including a booster or a low-pressure (LP) compressor 22 followed downstream by a high-pressure (HP) compressor 24, a combustion section 26, a turbine section 27 including a high-pressure (HP) turbine 28 followed downstream by a low-pressure (LP) turbine 30, and a jet exhaust nozzle section 32. A high-pressure (HP) shaft 34 or a spool drivingly connects the HP turbine 28 to the HP compressor 24, to rotate the HP turbine 28 and the HP compressor 24 in unison. A low-pressure (LP) shaft 36 or a spool drivingly connects the LP turbine 30 to the LP compressor 22, to rotate the LP turbine 30 and the LP compressor 22 in unison. The compressor section 21, the combustion section 26, the turbine section 27, and the jet exhaust nozzle section 32 together define a core air flowpath.

For the embodiment depicted in FIG. 1, the fan section 14 includes a fan 38 (e.g., a variable pitch fan) having a plurality of fan blades 40 (airfoils) coupled to a disk 42 in a spaced apart manner. As depicted in FIG. 1, the fan blades 40 extend outwardly from the disk 42 generally along the radial direction R. Each fan blade 40 is rotatable relative to the disk 42 about a pitch axis P by virtue of the fan blades 40 being operatively coupled to an actuation member 44 configured to collectively vary the pitch of the fan blades 40 in unison. The fan blades 40, the disk 42, and the actuation member 44 are together rotatable about the longitudinal centerline axis 12 via a fan shaft 45 that is powered by the LP shaft 36 across a power gearbox, also referred to as a gearbox assembly 46. The gearbox assembly 46 is shown schematically in FIG. 1. The gearbox assembly 46 includes a plurality of gears for adjusting the rotational speed of the fan shaft 45 and, thus, the fan 38 relative to the LP shaft 36.

Referring still to the embodiment of FIG. 1, the disk 42 is covered by a rotatable fan hub 48 aerodynamically contoured to promote an airflow through the plurality of fan blades 40. In addition, the fan section 14 includes an annular fan casing or a nacelle 50 that circumferentially surrounds the fan 38 or at least a portion of the turbo-engine 16, or both. The nacelle 50 is supported relative to the turbo-engine 16 by a plurality of circumferentially spaced outlet guide vanes 52 (e.g., VSVs). Moreover, a downstream section 54 of the nacelle 50 extends over an outer portion of the turbo-engine 16 to define a bypass airflow passage 56 therebetween.

During operation of the turbine engine 10, a volume of air 58 enters the turbine engine 10 through an inlet 60 of the nacelle 50 or the fan section 14, or both. As the volume of air 58 passes across the fan blades 40 (rotating airfoils), a first portion of air 62 is directed or routed into the bypass airflow passage 56, and a second portion of air 64 is directed or is routed into the upstream section of the core air flowpath, or, more specifically, into the annular inlet 20 of the LP compressor 22. The ratio between the first portion of air 62 and the second portion of air 64 is commonly known as a bypass ratio. The pressure of the second portion of air 64 is then increased, forming compressed air 65, and the compressed air 65 is routed through the HP compressor 24 and into the combustion section 26, where the compressed air 65 is mixed with fuel and burned to generate combustion gases 66. The fuel can be a hydrogen fuel. The fuel can be transported from a fuel reservoir 100 using a fuel pipe 102 to the combustion section 26.

The combustion gases 66 are routed into the HP turbine 28 and expanded through the HP turbine 28 where a portion of thermal energy or kinetic energy, or both, from the combustion gases 66 is extracted via sequential stages of HP turbine stator vanes 68 (e.g., VSVs) that are coupled to the outer casing 18 and HP turbine rotor blades 70 (rotating airfoils) that are coupled to the HP shaft 34, thus, causing the HP shaft 34 to rotate, thereby supporting operation of the HP compressor 24. The combustion gases 66 are then routed into the LP turbine 30 and expanded through the LP turbine 30. Here, a second portion of the thermal energy and the kinetic energy is extracted from the combustion gases 66 via sequential stages of LP turbine stator vanes 72 (e.g., VSVs) that are coupled to the outer casing 18 and LP turbine rotor blades 74 (rotating airfoils) that are coupled to the LP shaft 36, thus, causing the LP shaft 36 to rotate, thereby supporting operation of the LP compressor 22 and rotation of the fan 38 via the gearbox assembly 46. The term “stator” in “stator vanes” is used herein to mean that the vanes are not rotatable around the longitudinal centerline axis 12 of the turbine engine 10. However, the “stator vanes” can be variable stator vanes (VSVs) in the sense that each vane may be rotatable around the longitudinal axis of the vane to direct airflow.

The combustion gases 66 are subsequently routed through the jet exhaust nozzle section 32 of the turbo-engine 16 to provide propulsive thrust. Simultaneously, the pressure of the first portion of air 62 is substantially increased as the first portion of air 62 is routed through the bypass airflow passage 56 before being exhausted from a fan nozzle exhaust section 76 of the turbine engine 10, also providing propulsive thrust. The HP turbine 28, the LP turbine 30, and the jet exhaust nozzle section 32 at least partially define a hot gas path 78 for routing the combustion gases 66 through the turbo-engine 16.

The turbine engine 10 depicted in FIG. 1 is by way of example only. In other embodiments, the turbine engine 10 may have any other suitable configuration. For example, in other embodiments, the fan 38 may be configured in any other suitable manner (e.g., as a fixed pitch fan) and further may be supported using any other suitable fan frame configuration.

Moreover, in other embodiments, any other suitable number or configuration of compressors, turbines, shafts, or a combination thereof may be provided. In still other embodiments, aspects of the present disclosure may be incorporated into any other suitable turbine engine, such as, for example, turbofan engines, propfan engines, turbojet engines, turboprop, or turboshaft engines.

The turbine engine 10 discussed herein is suitable for use on aircraft. Suitable aircraft include, for example, airplanes and unmanned aerial vehicles (UAV). In other embodiments, the turbine engine can be any other turbine engine, such as an industrial turbine engine incorporated into a power generation system, or a nautical turbine engine on a ship or other vessel.

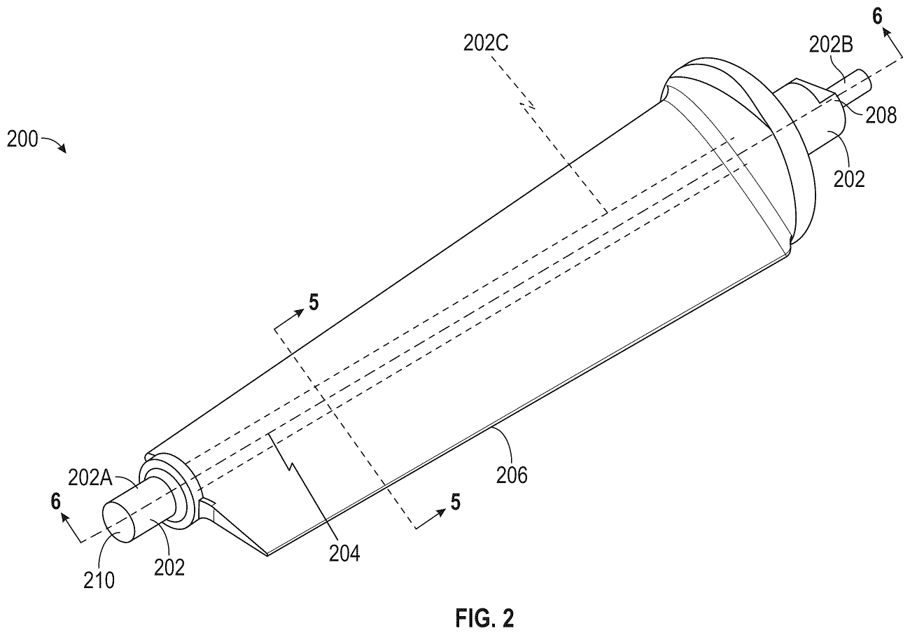

FIG. 2 is a schematic, perspective view of a variable stator vane (VSV) 200, according to an embodiment of the present disclosure. The VSV 200 includes a shaft 202 (also referred to as a trunnion, a spar, or a spindle) defining the longitudinal axis 204 of the VSV 200. The VSV 200 also includes an airfoil portion 206 coupled to a shaft portion 202C. The airfoil portion 206 and the shaft 202 are rotatable around the longitudinal axis 204 of the VSV 200 to direct airflow.

In an embodiment, the VSV 200 is supported at an inner diameter (ID) 208 and an outer diameter (OD) 210 of the VSV 200. The VSV 200 is configured to rotate around the longitudinal axis 204 of the VSV 200 to direct airflow.

In an embodiment, the shaft 202 includes a first metallic end 202A and a second metallic end 202B, and a shaft portion 202C between the first metallic end 202A and the second metallic end 202B. The shaft portion 202C is essentially made of a first composite material. The term “essentially made of a first composite material” is used herein to mean that the shaft portion 202C is made eighty percent (80%) to one hundred percent (100%) of a first composite material. The shaft portion 202C is coupled to the first metallic end 202A and the second metallic end 202B. In an embodiment, the shaft 202 includes the first metallic end 202A at the OD 210 and the second metallic end 202B at the ID 208 to add rigidity to the VSV 200 and to provide wear resistance. In an embodiment, the first metallic end 202A of the shaft 202 and the second metallic end 202B of the shaft 202 occupy less than or equal to twenty-five percent (25%) of a total span of the shaft 202 or a total span of the VSV 200. In an embodiment, the first metallic end 202A of the shaft 202 and the second metallic end 202B of the shaft 202 occupy from ten percent (10%) to twenty-five percent (25%) of the total span of the VSV 200. Therefore, seventy-five percent (75%) or more of the total span of the VSV 200 is occupied by the shaft portion 202C.

In an embodiment, the airfoil portion 206 is essentially made of a composite material to reduce weight of the VSV 200. In addition, the shaft portion 202C is also essentially made of a composite material to further reduce weight of the VSV 200. In an embodiment, the shaft portion 202C is essentially made of a first composite material and the airfoil portion 206 of the VSV 200 can be formed by wrapping a second composite material around the shaft portion 202C. The term “essentially made of a first composite material” is used herein to mean that the shaft portion 202C is made eighty percent (80%) to one hundred percent (100%) of a composite material. The term “essentially made of a second composite material” is used herein to mean that the airfoil portion 206 is made eighty percent (80%) to one hundred percent (100%) of a composite material. For example, the airfoil portion 206 may include a non-composite material (e.g., foam), as described further below.

In an embodiment, the first composite material of the shaft portion 202C is the same as the second composite material of the airfoil portion 206 of the VSV 200. In another embodiment, the first composite material of the shaft portion 202C is different from the second composite material of the airfoil portion 206 of the VSV 200.

In an embodiment, the shaft portion 202C may have a first composite material architecture and the airfoil portion 206 may have a second composite material architecture. The first composite material of the shaft portion 202C has the first composite material architecture and the second material of the airfoil portion 206 has the second composite material architecture. In an embodiment the first composite material architecture of the shaft portion 202C can be the same as the second composite material architecture of the airfoil portion 206. In another embodiment, the first composite material architecture of the shaft portion 202C is different from the second composite material architecture of the airfoil portion 206. For example, the first composite material architecture of the shaft portion 202C may be a laminate composite material architecture while the second composite material architecture of the airfoil portion 206 may be a braided composite material architecture, or vice versa.

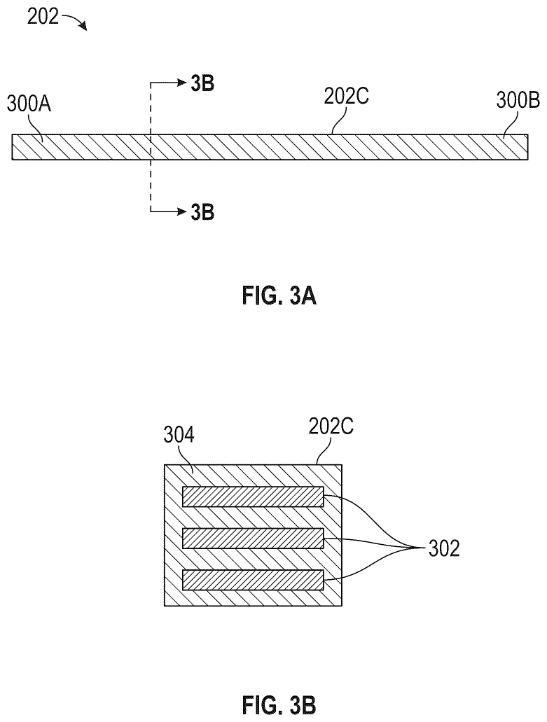

FIG. 3A is a schematic, cross-sectional view of the shaft portion 202C of the shaft 202 of the VSV 200, according to an embodiment of the present disclosure. The shaft portion 202C is essentially made of a composite material. The shaft portion 202C has a first end 300A and a second end 300B (opposite the first end 300A) that are configured to be coupled to the first metallic end 202A and the second metallic end 202B, respectively.

FIG. 3B is a schematic, cross-sectional view of the shaft portion 202C of the shaft 202 taken at line 3B-3B, shown in FIG. 3A, according to an embodiment of the present disclosure. As shown in FIG. 3B, in an embodiment, the shaft portion 202C is made of a laminate composite material having a plurality of stacked laminates 302. The plurality of stacked laminates 302 are embedded in a matrix material 304 (e.g., a polymer matrix or a ceramic matrix, etc.) to form the shaft portion 202C.

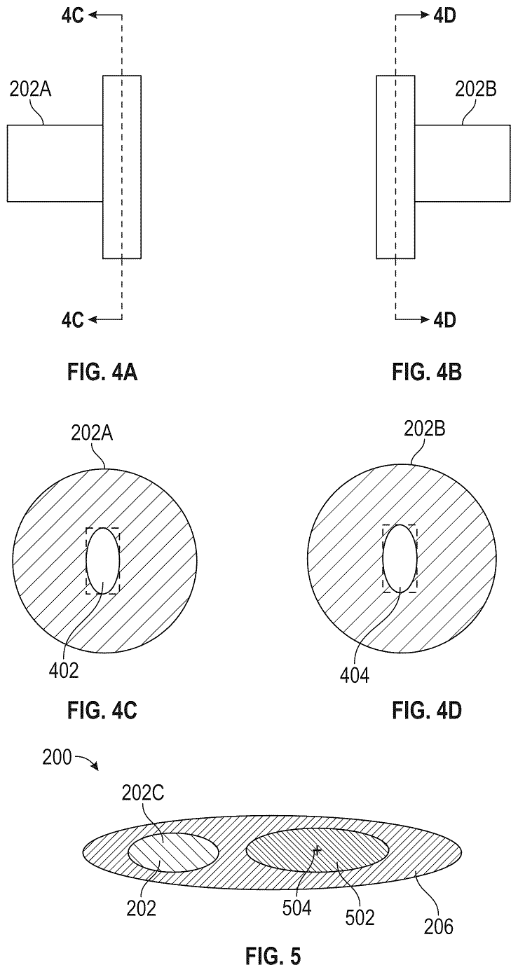

FIG. 4A is a schematic, elevational view of the first metallic end 202A of the shaft 202, according to an embodiment of the present disclosure. FIG. 4B is a schematic, elevational view of the second metallic end 202B of the shaft, according to an embodiment of the present disclosure. The first metallic end 202A and the second metallic end 202B can be metallic bushings connected to the shaft portion 202C, shown in FIG. 3A, that is essentially made of a composite material. The term “essentially made of a composite material” is used herein to mean that the shaft portion 202C is made eighty percent (80%) to one hundred percent (100%) of a composite material.

FIG. 4C is a schematic, cross-sectional view of the first metallic end 202A taken at line 4C-4C shown in FIG. 4A, according to an embodiment of the present disclosure. In an embodiment, as shown in FIG. 4C, the first metallic end 202A can have a first hole 402. The first hole 402 in the first metallic end 202A is configured to receive the first end 300A of the shaft portion 202C. In an embodiment, the first hole 402 has a shape that matches a shape of the first end 300A of the shaft portion 202C, shown in FIG. 3A. For example, the shape of the first hole 402 can be an oval shape. In this case, the shape of the first end 300A of the shaft portion 202C is also oval so as to be inserted into the first hole 402. However, other shapes can be used such as a polygonal shape (e.g., rectangular, square, hexagonal, etc.). In an embodiment, the first metallic end 202A can be fastened or adhered to the first end 300A of the shaft portion 202C using a fastener or an adhesive. For example, the adhesive can be applied to the first end 300A of the shaft portion 202C or to an interior surface of the hole 402, or both, before inserting the first end 300A of the shaft portion 202C into the first hole 402.

FIG. 4D is a schematic cross-sectional view of the second metallic end 202B taken at line 4D-4D shown in FIG. 4B, according to an embodiment of the present disclosure. In an embodiment, as shown in FIG. 4D, the second metallic end 202B can have a second hole 404. The second hole 404 in the second metallic end 202B is configured to receive the second end 300B of the shaft portion 202C. In an embodiment, the second hole 404 has a shape that matches a shape of the second end 300B of the shaft portion 202C, shown in FIG. 3A. For example, the shape of the second hole 404 can be an oval shape. In this case, the shape of the second end 300B of the shaft portion 202C is also oval so as to be inserted into the second hole 404. However, other shapes can be used such as a polygonal shape (e.g., rectangular, square, hexagonal, etc.). In an embodiment, the second metallic end 202B can be fastened or adhered to the second end 300B of the shaft portion 202C using a fastener or an adhesive. For example, the adhesive can be applied to the second end 300B of the shaft portion 202C or to an interior surface of the second hole 404, or both, before inserting the second end 300B of the shaft portion 202C into the second hole 404.

FIG. 5 is a schematic cross-sectional view of the VSV 200 taken at line 5-5 shown in FIG. 2, according to an embodiment of the present disclosure. As shown in FIG. 5, the VSV 200 includes the shaft 202 and the airfoil portion 206. The shaft 202 is located at a position that is shifted relative to a centroid 504 of the airfoil portion 206. In an embodiment, the shaft portion 202C of the shaft 202 has a cross-sectional shape that follows a profile of the airfoil portion 206 so that, when wrapping composite material around the shaft portion 202C to form the airfoil portion 206, less composite material is used around the shaft portion 202C, and the obtained shape of the airfoil portion 206 near the shaft portion 202C follows the shape of the shaft 202.

In an embodiment, the airfoil portion 206 may include a non-composite material 502 (e.g., 502). For example, the non-composite material 502 (e.g., foam) can be provided within the airfoil portion away from the shaft 202 to reduce weight and/or to reduce rotational inertia of the VSV 200. The non-composite material has a density less than or equal to a density of the second composite material of the airfoil portion 206.

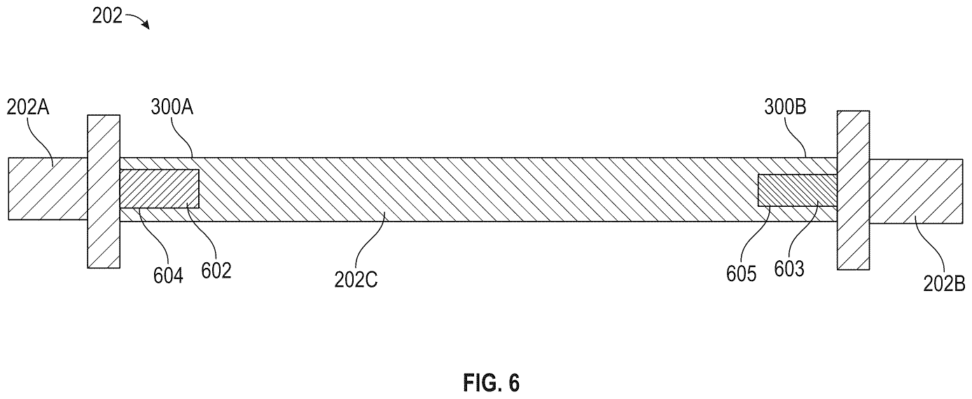

FIG. 6 is a schematic, cross-sectional view of the VSV 200 taken along line 6-6 shown in FIG. 2, according to an embodiment of the present disclosure. In this embodiment, as shown in FIG. 6, the shaft 202 includes the first metallic end 202A, the second metallic end 202B, and the shaft portion 202C made essentially of composite material. The shaft also includes a first metallic insert 602 provided to couple the first metallic end 202A to the shaft portion 202C and a second metallic insert 603 provided to couple the second metallic end 202B to the shaft portion 202C. In this embodiment, instead of inserting the shaft portion 202C into the first hole 402 in the first metallic end 202A (as shown in FIG. 4A), the first metallic insert 602 is instead inserted into a first shaft hole 604 at the first end 300A of the shaft portion 202C of the shaft 202. The first shaft hole 604 is configured to receive the first metallic insert 602. The first metallic insert 602 can be fastened (e.g., screwed) to the first metallic end 202A. The first metallic insert 602 can be adhered to the first end 300A of the shaft portion 202C of the shaft 202. For example, an adhesive can be applied to the first metallic insert 602 or to the interior surface of the first shaft hole 604, or to both, and the first metallic insert 602 can then be inserted into the first shaft hole 604 at the first end 300A of the shaft portion 202C of the shaft 202.

Similarly, the second metallic insert 603 is also inserted into a second shaft hole 605 at the second end 300B of the shaft portion 202C of the shaft 202. The second shaft hole 605 is configured to receive the second metallic insert 603. The second metallic insert 603 can be fastened (e.g., screwed) to the second metallic end 202B. The second metallic insert 603 can be adhered to the second end 300B of the shaft portion 202C of the shaft 202. For example, an adhesive can be applied to the second metallic insert 603 or to the interior surface of the second shaft hole 605, or to both, and the second metallic insert 603 can then be inserted into the second shaft hole 605 at the second end 300B of the shaft portion 202C of the shaft 202.

Further aspects are provided by the subject matter of the following clauses.

A variable stator vane comprises a shaft defining a longitudinal axis of the variable stator vane, the shaft having a first metallic end and a second metallic end coupled to a shaft portion, the shaft portion being made essentially of a first composite material to reduce weight of the variable stator vane, and an airfoil portion coupled to the shaft portion, the airfoil portion being made essentially of a second composite material, the shaft and the airfoil portion being rotatable around the longitudinal axis of the variable stator vane.

The variable stator vane of the preceding clause, the first metallic end and the second metallic end being metallic bushings connected to the shaft portion.

The variable stator vane of any preceding clause, the first metallic end and the second metallic end are configured to add rigidity and to provide wear resistance to the variable stator vane.

The variable stator vane of any preceding clause, the first composite material of the shaft portion being the same as the second composite material of the airfoil portion.

The variable stator vane of any preceding clause, the first metallic end being located at an outer diameter of the variable stator vane, and the second metallic end is located at an inner diameter of the variable stator vane.

The variable stator vane of any preceding clause, the shaft being located at a position that is shifted relative to a centroid of the airfoil portion.

The variable stator vane of any preceding clause, the shaft having a cross-sectional shape that follows a profile of the airfoil portion.

The variable stator vane of any preceding clause, the airfoil portion including a non-composite material, the non-composite material having a density less than or equal to a density of the second composite material of the airfoil portion.

The variable stator vane of any preceding clause, the non-composite material comprising foam.

The variable stator vane of any preceding clause, the non-composite material being provided within the airfoil portion away from the shaft to reduce weight or to reduce rotational inertia, or both, of the variable stator vane.

The variable stator vane of any preceding clause, the first metallic end of the shaft and the second metallic end of the shaft being less than or equal to twenty-five percent of a total span of the shaft.

The variable stator vane of any preceding clause, the first composite material of the shaft portion having a first composite material architecture, and the second composite material of the airfoil portion has a second composite material architecture.

The variable stator vane of any preceding clause, the first composite material architecture being different from the second composite material architecture.

The variable stator vane of any preceding clause, the first composite material architecture of the shaft portion being a laminate composite material architecture, and the second composite material architecture of the airfoil portion is a braided composite material architecture.

The variable stator vane of any preceding clause, the laminate composite material architecture comprising a plurality of stacked laminates embedded in a matrix material.

The variable stator vane of any preceding clause, the shaft portion having a first end and a second end, the first end being coupled to the first metallic end and the second end being coupled to the second metallic end.

The variable stator vane of any preceding clause, the first metallic end having a first hole that is configured to receive the first end of the shaft portion, and the second metallic end has a second hole that is configured to receive the second end of the shaft portion.

The variable stator vane of any preceding clause, the first hole having a shape that matches a shape of the first end of the shaft portion and the second hole has a shape that matches a shape of the second end of the shaft portion.

The variable stator vane of any preceding clause, the first end of the shaft portion being configured to be inserted into the first hole of the first metallic end, and the first metallic end is fastened to the first end of the shaft portion, or the second end of the shaft portion is configured to be inserted into the second hole of the second metallic end, and the second metallic end is fastened to the second end of the shaft portion, or both.

The variable stator vane of any preceding clause, the shaft further comprising a first metallic insert and a second metallic insert, the first end of the shaft portion comprises a first shaft hole configured to receive the first metallic insert, the first metallic insert being coupled to the first metallic end, or the second end of the shaft portion comprises a second shaft hole configured to receive the second metallic insert, the second metallic insert being coupled to the second metallic end, or both.

The variable stator vane of any preceding clause, the first metallic insert being configured to be fastened to the first metallic end, or the second metallic insert is configured to be fastened to the second metallic end, or both.

The variable stator vane of any preceding clause, the first metallic insert being adhered to the first end of the shaft portion, or the second metallic insert is adhered to the second end of the shaft portion, or both, using an adhesive.

A turbine engine comprising a plurality of variable stator vanes, each variable stator vane comprising a shaft defining a longitudinal axis of the variable stator vane, the shaft having a first metallic end and a second metallic end coupled to a shaft portion, the shaft portion being made essentially of a first composite material to reduce weight of the variable stator vane, and an airfoil portion coupled to the shaft portion, the airfoil portion being made essentially of a second composite material, the shaft and the airfoil portion being rotatable around the longitudinal axis of the variable stator vane.

The turbine engine of the preceding clause, the first metallic end and the second metallic end being metallic bushings connected to the shaft portion.

The turbine engine of any preceding clause, the first metallic end and the second metallic end are configured to add rigidity and to provide wear resistance to the variable stator vane.

The turbine engine of any preceding clause, the first composite material of the shaft portion being the same as the second composite material of the airfoil portion.

The turbine engine of any preceding clause, the first metallic end being located at an outer diameter of the variable stator vane, and the second metallic end is located at an inner diameter of the variable stator vane.

The turbine engine of any preceding clause, the shaft being located at a position that is shifted relative to a centroid of the airfoil portion.

The turbine engine of any preceding clause, the shaft having a cross-sectional shape that follows a profile of the airfoil portion.

The turbine engine of any preceding clause, the airfoil portion including a non-composite material, the non-composite material having a density less than or equal to a density of the second composite material of the airfoil portion.

The turbine engine of any preceding clause, the non-composite material comprising foam.

The turbine engine of any preceding clause, the non-composite material comprising being provided within the airfoil portion away from the shaft to reduce weight or to reduce rotational inertia, or both, of the variable stator vane.

The turbine engine of any preceding clause, the first metallic end of the shaft and the second metallic end of the shaft being less than or equal to twenty-five percent of a total span of the shaft.

The turbine engine of any preceding clause, the first composite material of the shaft portion having a first composite material architecture, and the second composite material of the airfoil portion has a second composite material architecture.

The turbine engine of any preceding clause, the first composite material architecture being different from the second composite material architecture.

The turbine engine of any preceding clause, the first composite material architecture of the shaft portion being a laminate composite material architecture, and the second composite material architecture of the airfoil portion is a braided composite material architecture.

The turbine engine of any preceding clause, the laminate composite material architecture comprising a plurality of stacked laminates embedded in a matrix material.

The turbine engine of any preceding clause, the shaft portion having a first end and a second end, the first end being coupled to the first metallic end and the second end being coupled to the second metallic end.

The turbine engine of any preceding clause, the first metallic end having a first hole that is configured to receive the first end of the shaft portion, and the second metallic end has a second hole that is configured to receive the second end of the shaft portion.

The turbine engine of any preceding clause, the first hole having a shape that matches a shape of the first end of the shaft portion and the second hole has a shape that matches a shape of the second end of the shaft portion.

The turbine engine of any preceding clause, the first end of the shaft portion being configured to be inserted into the first hole of the first metallic end, and the first metallic end is fastened to the first end of the shaft portion, or the second end of the shaft portion is configured to be inserted into the second hole of the second metallic end, and the second metallic end is fastened to the second end of the shaft portion, or both.

The turbine engine of any preceding clause, the shaft further comprising a first metallic insert and a second metallic insert, the first end of the shaft portion comprises a first shaft hole configured to receive the first metallic insert, the first metallic insert being coupled to the first metallic end, or the second end of the shaft portion comprises a second shaft hole configured to receive the second metallic insert, the second metallic insert being coupled to the second metallic end, or both.

The turbine engine of any preceding clause, the first metallic insert being configured to be fastened to the first metallic end, or the second metallic insert is configured to be fastened to the second metallic end, or both.

The turbine engine of any preceding clause, the first metallic insert being adhered to the first end of the shaft portion, or the second metallic insert is adhered to the second end of the shaft portion, or both, using an adhesive.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A variable stator vane comprising:
a shaft defining a longitudinal axis of the variable stator vane, the shaft having a first metallic end and a second metallic end coupled to a shaft portion, the shaft portion being made essentially of a first composite material; and
an airfoil portion coupled to the shaft portion, the airfoil portion being made essentially of a second composite material,
wherein the shaft and the airfoil portion are rotatable around the longitudinal axis of the variable stator vane.

2. The variable stator vane of claim 1, wherein the first metallic end and the second metallic end are metallic bushings connected to the shaft portion.

3. The variable stator vane of claim 1, wherein the first composite material of the shaft portion is the same as the second composite material of the airfoil portion.

4. The variable stator vane of claim 1, wherein the first metallic end is located at an outer diameter of the variable stator vane, and the second metallic end is located at an inner diameter of the variable stator vane.

5. The variable stator vane of claim 1, wherein the shaft is located at a position that is shifted relative to a centroid of the airfoil portion.

6. The variable stator vane of claim 1, wherein the shaft has a cross-sectional shape that follows a profile of the airfoil portion.

7. The variable stator vane of claim 1, wherein the airfoil portion includes a non-composite material, the non-composite material having a density less than or equal to a density of the second composite material of the airfoil portion.

8. The variable stator vane of claim 1, wherein the first metallic end of the shaft and the second metallic end of the shaft are less than or equal to twenty-five percent of a total span of the shaft.

9. The variable stator vane of claim 1, wherein the first composite material of the shaft portion has a first composite material architecture, and the second composite material of the airfoil portion has a second composite material architecture.

10. The variable stator vane of claim 9, wherein the first composite material architecture is different from the second composite material architecture.

11. The variable stator vane of claim 10, wherein the first composite material architecture of the shaft portion is a laminate composite material architecture, and the second composite material architecture of the airfoil portion is a braided composite material architecture.

12. The variable stator vane of claim 11, wherein the laminate composite material architecture comprises a plurality of stacked laminates embedded in a matrix material.

13. The variable stator vane of claim 1, wherein the shaft portion has a first end and a second end, the first end being coupled to the first metallic end and the second end being coupled to the second metallic end.

14. The variable stator vane of claim 13, wherein the first metallic end has a first hole that is configured to receive the first end of the shaft portion, and the second metallic end has a second hole that is configured to receive the second end of the shaft portion.

15. The variable stator vane of claim 14, wherein the first hole has a shape that matches a shape of the first end of the shaft portion and the second hole has a shape that matches a shape of the second end of the shaft portion.

16. The variable stator vane of claim 14, wherein the first end of the shaft portion is configured to be inserted into the first hole of the first metallic end, and the first metallic end is fastened to the first end of the shaft portion, or the second end of the shaft portion is configured to be inserted into the second hole of the second metallic end, and the second metallic end is fastened to the second end of the shaft portion, or both.

17. The variable stator vane of claim 14, wherein the shaft further comprises a first metallic insert and a second metallic insert, the first end of the shaft portion comprises a first shaft hole configured to receive the first metallic insert, the first metallic insert being coupled to the first metallic end, or the second end of the shaft portion comprises a second shaft hole configured to receive the second metallic insert, the second metallic insert being coupled to the second metallic end, or both.

18. The variable stator vane of claim 17, wherein the first metallic insert is configured to be fastened to the first metallic end, or the second metallic insert is configured to be fastened to the second metallic end, or both.

19. The variable stator vane of claim 18, wherein the first metallic insert is adhered to the first end of the shaft portion, or the second metallic insert is adhered to the second end of the shaft portion, or both, using an adhesive.

20. A turbine engine comprising a plurality of variable stator vanes, each variable stator vane comprising:
a shaft defining a longitudinal axis of the variable stator vane, the shaft having a first metallic end and a second metallic end coupled to a shaft portion, the shaft portion being made essentially of a first composite material; and
an airfoil portion coupled to the shaft portion, the airfoil portion being made essentially of a second composite material,
wherein the shaft and the airfoil portion are rotatable around the longitudinal axis of the variable stator vane.
